(19) United States
(12) Patent Application Publication
(10) Pub. No.: US 2010/0264891 A1
(43) Pub. Date: Oct. 21, 2010

(54) Control Method for Voltage Converter and Related Voltage Converter

(76) Inventor: Ching-Tsan Lee, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/625,562

(22) Filed: Nov. 25, 2009

(30) Foreign Application Priority Data
Apr. 17, 2009 (TW) 098112831

(51) Int. Cl. G05F 1/10

(52) U.S. Cl. 323/282

(57) ABSTRACT

A control method for a voltage converter includes providing a setting for a power-saving mode; entering the power-saving mode, and according to the setting, making the voltage converter output a preset level of energy; entering a normal mode, determining whether the voltage converter should enter into the power-thrift mode, and detecting an output response of the voltage converter; and adjusting the setting based upon the output response, to make the output response approximately be maintained in a preset range.

### BACKGROUND OF THE INVENTION

1. Field of the Invention

The present invention relates to a control method for a voltage converter and related voltage converters, and more particularly, to a control method and related voltage converters that operate in a specific frequency range when staying in a power saving mode.

2. Description of the Prior Art

According to the prior art, a switching power supply can operate in a pulse width modulation (PWM) mode, which can provide a load a stable output voltage by changing duty cycles of a power switch. When the impedance of the load changes, current provided to the load changes accordingly. For an ideal switching power supply, a highly stable output level of voltage is of importance despite of the change in the load. In practice, the switching power supply increases the duty cycle when the load increases, and vice versa. Under the condition of a light load or no load, some switching power supply was designed to operate in a burst or skip mode which means that power conversion is stopped in one or several consecutive switching periods for lowering the switching loss of the power switch.

The working principles of the switching power supply can be referred to FIG. 1 illustrating a schematic diagram of a buck switching power supply 10 in the art. Power supply circuit 10 includes power source VIN, voltage converter 100, high-side switch HG, low-side switch LG, inductor L1, capacitor C1, resistors R1, R2, and a load Z1. FIG. 2A illustrates a schematic diagram of signal waveforms of high-side switch HG, low-side switch LG, and inductor current I_L1 in a normal load condition.

In FIG. 2A, the waveform of inductor current I_L1 is a continuous triangular wave, implying a continuous conduction mode (CCM), and an average level of inductor current I_L1 implies the load current required by load Z1 for maintaining the output voltage level. If load Z1 is light or disappears, the average level of inductor current I_L1 should approach to a current level very close to zero. In this case, maintaining the waveform of the inductor current in FIG. 2A implies that inductor current I_L1 is negative in some duration in a switching period, causing the “reverse current” which adversely consumes the electrical energy stored in output capacitor C1. To reduce or to prevent the occurrence of the reverse current, reverse current prevention mechanism was developed to turn off the low-side switch LG when the conditions that the reverse current is going to happen or already happened are detected. The resulting waveform is then as illustrated in FIG. 2B, and the waveform of the inductor current becomes a discontinuous triangular wave, which is also known as the discrete conduction mode (DCM).

In FIG. 1, if it is found that the reverse current prevention mechanism starts to take effect, condition of light load or no load can be presumed and operation in the burst mode might be triggered. Meanwhile, to decide how the switching power supply circuit 10 operates in the burst mode is an important and essential issue, and deserves further investigation.

### SUMMARY OF THE INVENTION

An embodiment of the present invention discloses a control method for a voltage converter. The control method comprises: providing a setting for a power saving mode, making the voltage converter output a preset level of energy according to the setting while entering the power-saving mode, and entering a normal mode, on which the control method detects an output response of the voltage converter and determines whether the voltage converter should enter into the power saving mode. The control method also adjusts the setting according to the output response such that the output response is approximately maintained in a preset range.

An embodiment of the present invention further discloses a voltage converter. The voltage converter comprises a state detector for detecting an output of the voltage converter in order to determine whether the voltage converter should enter a power saving mode or a normal mode. The voltage converter also comprises an output energy determinator, which comprises a setting register for storing a setting and adjusting the setting according to an output response of the voltage converter in the normal mode such that the output response is approximately maintained in a preset range. The voltage converter also comprises a switch controller for controlling a power switch, which is operated either in a power saving mode or in a normal mode, and when operated in the power saving mode, the switch controller makes the voltage converter output a preset level of energy according to the setting stored in the setting register.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a buck switching power supply of the prior art.

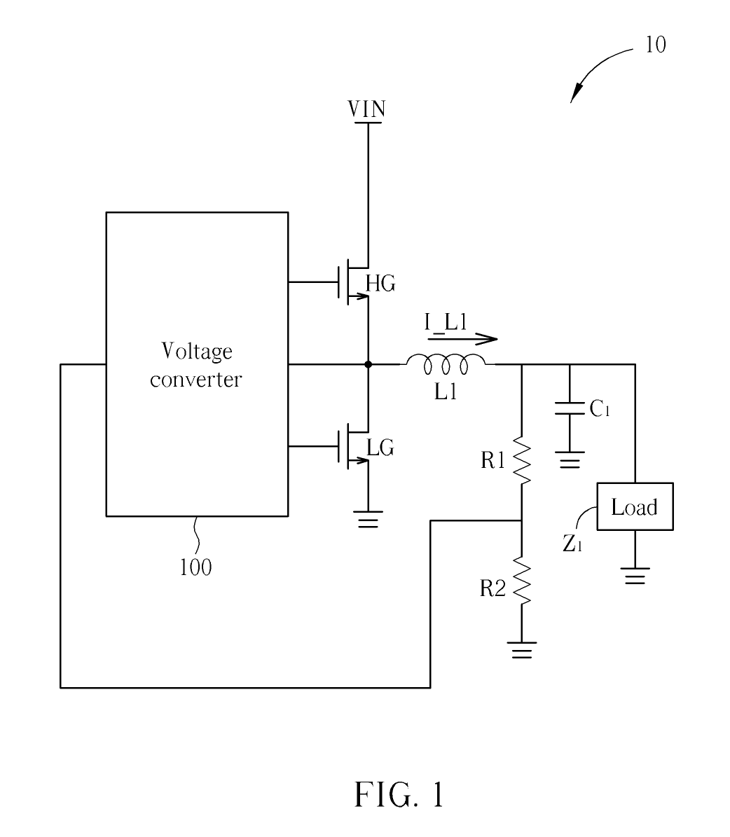

FIG. 2A illustrates a schematic diagram of signal waveforms of a high-side switch, a low-side switch and an inductor current of the buck switching power supply of FIG. 1 in a normal load condition.

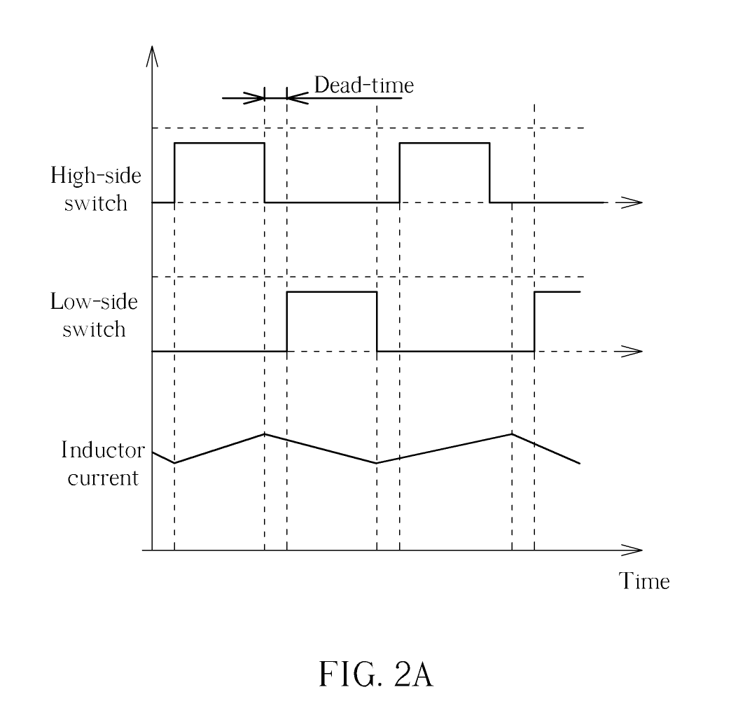

FIG. 2B illustrates a schematic diagram of signal waveforms of the high-side switch, the low-side switch and the inductor current of the buck switching power supply of FIG. 1 in a light load condition.

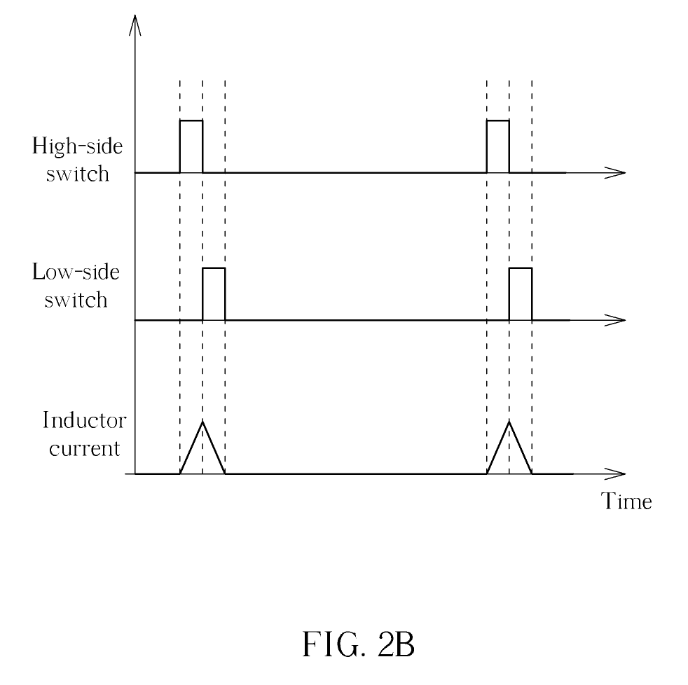

FIG. 3 illustrates a schematic diagram of a switching power supply circuit according to the present invention.

FIG. 4 illustrates a schematic diagram of a voltage converter shown in FIG. 3 according to an embodiment of the present invention.

FIG. 5 illustrates a state diagram of the power supply circuit shown in FIG. 3 according to an embodiment of the present invention.

FIG. 6 illustrates a signal diagram of a high-side switch, a low-side switch, and an inductor current of the switching power supply circuit of FIG. 3 operating in a light load condition according to an embodiment of the present invention.

### DETAILED DESCRIPTION

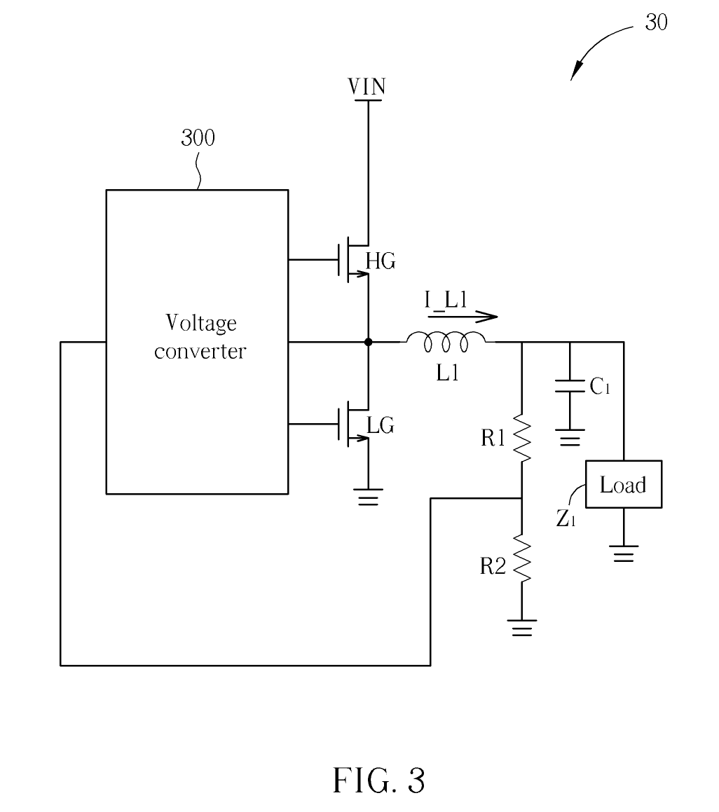

Please refer to FIG. 3, illustrating a schematic diagram of a switching power supply circuit 30 according to the present invention. Switching power supply circuit 30 comprises power source VIN, voltage converter 300, high-side switch HG, low-side switch LG, inductor L1, capacitor C1, resistors R1 and R2, and load Z1. The main difference between power supply switch 30 and power supply circuit 10 is that voltage converter 100 of the prior art has been replaced by voltage converter 300 of the present invention.

According to various operating conditions, voltage converter 300 comprises at least two operating modes of a PWM mode and a burst mode representing a normal mode and a power saving mode, respectively. In the PWM mode, it is possible for switching power supply circuit 30 to operate in continuous conduction mode (CCM) or discrete conduction mode (DCM). Besides, a “non-switching period” refers to a switching period in that both high-side switch HG and low-side switch LG are constantly OFF and the current of inductor L1 constantly 0. In one embodiment according to the present invention, voltage converter 300 is used to limit the time interval between two consecutive times when switching power supply circuit 30 enters into the burst mode, making the time interval an approximate constant or within a preset range, while the load Z1 is a light load or even no load.

For example, voltage converter 300, when entering the burst mode, is forced to transfer an amount of excessive energy to capacitor C1 and load Z1. Voltage converter 300 then enters the PWM mode and experiences at least one non-switching period because the excessive energy slightly over charges capacitor C1 and load Z1. When the excessive energy is consumed, voltage converter 300 automatically modulates its ON duty ratios and transfers energy based on signals fed back from capacitor C1 and load Z1. Criterion is set for voltage converter 300 to find whether light load or no load occurs and to enter the burst mode again. The amount of excessive energy transferred to capacitor C1 and load Z1 may be adjusted to keep the time interval between two consecutive times of entering the burst/skip mode close to a constant or within a preset range.

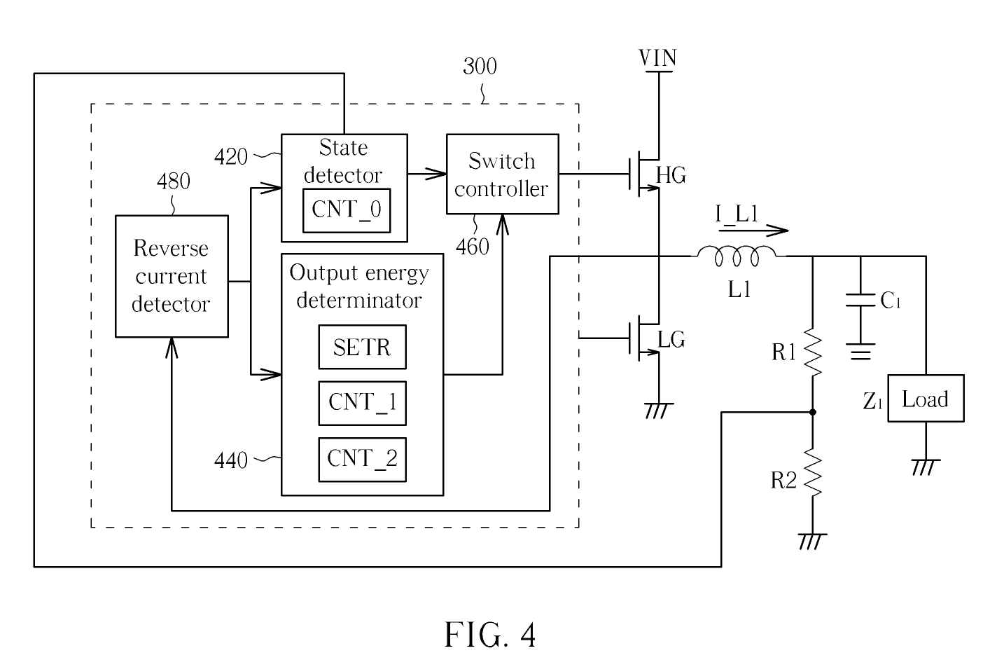

Please refer to FIG. 4, illustrating a schematic diagram of voltage converter 300 shown in FIG. 3. Voltage converter 300 comprises state detector 420, output energy determinator 440, switch controller 460 and reverse current detector 480.

State detector 420 is used for detecting the number of consecutive times voltage converter 300 outputting in DCM to judge whether voltage converter 300 enters into the burst mode or stays in the PWM mode. State detector 420 comprises a counter CNT_0, which is coupled to the reverse current detector 480 and used to count the number NUM_{DCM} of consecutive times when voltage converter 300 operates in DCM while operating in the PWM mode. If NUM_{DCM} is greater than a preset value, the load is considered as a light load or no load, and state detector 420 will then direct the voltage converter 300 to enter the burst mode.

The output energy determinator 440 comprises a setting register SETR used for storing a burst current value outputted by voltage converter 300 operating in the burst mode. The burst current value is used to define the maximal allowable current flowing through the inductor L1 in the burst mode. The setting in register SETR can be adjusted according to the number of consecutive non-switching periods of voltage converter 300 operating in the PWM mode, such that the number of consecutive non-switching periods can be maintained in a preset range. Switch controller 460 can control high-side switch HG and low-side switch LG to be operated in the burst mode or the PWM mode. Output energy determinator 440 comprises two counters CNT_1 and CNT_2. Counter CNT_1 counts the number NUM_{CCM} of consecutive times when voltage converter 300 outputs in CCM. Counter CNT_2, coupled to reverse current detector 480, counts the number NUM_{NON} of consecutive non-switching periods of voltage converter 300 while operating in the PWM mode.

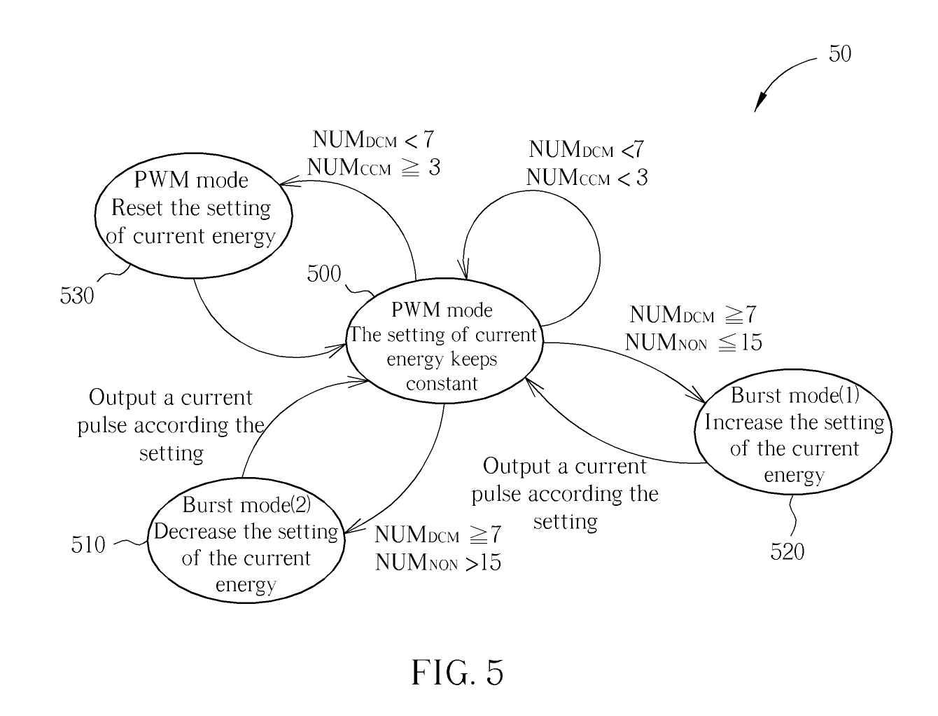

FIG. 5 illustrates a state diagram 50 of the power supply circuit 30 depicted in FIG. 3. In this embodiment of the present invention, the working principles of the state diagram 50 can be briefly stated as follows:

Started from state 500, voltage converter 300 operates in the PWM mode. In state 500, if NUM_{DCM} is found to be greater than or equal to 7, the load is consequently judged as a light load or no load, and then voltage converter 300 will enter into the burst mode and its operation moves to either state 510 or state 520 according to NUM_{NON}. If NUM_{DCM} is less than 7 and NUM_{CCM} is less than 3, which implies that the load is uncertain in a light load or heavy load, voltage converter 300 will keep staying in state 500, operating in the PWM mode. If NUM_{DCM} is less than 7 and NUM_{CCM} is greater than or equal to 3, this condition implies that the load is heavy load and voltage converter 300 will enter into state 530. In state 530, the burst current value is set (or reset) to a preset value, and then voltage converter 300 will back to state 500, keeping operating in the PWM mode.

If NUM_{DCM} is greater than or equal to 7, voltage converter 300 is going to enter the burst mode. Every time when entering the burst mode, voltage converter 300 transfers an amount of excessive energy to the load, and the amount is determined or altered based on NUM_{NON}. A NUM_{NON} larger than expected, for example larger than 15, implies that the amount of excessive energy transferred at the last time entering the burst mode is considered as being too much and resulting too many consecutive non-switching periods. Therefore, the operating enters into state 510 and the burst current value recorded in output energy determinator 440 is decreased. After the burst current value has been decreased, voltage converter 300 enters into the burst mode and controls the high-side switch HG according to the updated burst current value to output at least one triangular wave of current, whose peak value is made to be substantially equal to the updated burst current value. After outputting the triangular wave of current, voltage converter 300 will go back to state 500, entering into the PWM mode. As can be predicted, if the load remains unchanged, because the amount of excessive energy transferred has been decreased compared with the previous one, the next NUM_{NON} should be decreased accordingly, implying that the time before voltage converter 300 next entering into the burst mode will be earlier.

Similarly, when NUM_{DCM} is greater than or equal to 7 and NUM_{NON} is less than expected, for example NUM_{NON}<=15, implying that consecutive non-switching periods are too few, voltage converter 300 will enter state 520, and increase the burst current value stored in output energy determinator 440. After the burst current value has been increased, voltage converter 300 enters into the burst mode and controls the high-side switch HG according to the updated burst current value to output at least one triangular wave of current and control the peak value of the current to be equal to the updated burst current value. After outputting the triangular wave of current, voltage converter 300 backs to state 500, entering the PWM mode. As can be predicted, if the load remains unchanged, since the amount of excessive energy transferred has been increased, voltage converter 300 will later enter the burst mode next time and the next NUM_{NON} will be increased.

Noteworthily, all the preset numbers for the outputs of the counters to compare (e.g. NUM_{DCM}, NUM_{NON}, NUM_{CCM}) in FIG. 5 can be adjusted according to the system requirements (for example, the operating frequency of power supply circuit 30) to achieve the best performance. The amount of the excessive energy can also be outputted with different output current pulse widths. For example, besides the method of changing the burst current value, another method for changing the amount of excessive energy can also be achieved by changing the “ON” time of high-side switch HG, such that output energy determinator 440 records a value about the “ON” time of high-side switch HG in the burst mode. Alternatively, changing the amount of excessive energy can also be done by changing the number of the triangular waves of current in the burst mode but keeping constant the “ON” time of high-side switch HG or the burst current value. Voltage converter 30 goes back to state 500 of the PWM mode immediately after outputting the amount of the excessive energy. Briefly speaking, after affirming voltage converter 30 entering into the burst mode, the embodiment according to the present invention will output excessive energy to the inductor such that the voltage across the capacitor is slightly over charged and reaches a higher level. By this method, voltage converter 30 can be let free from turning on and off high-side switch HG for a longer period of time, and thus the switching loss can be decreased and the system power efficiency can be increased. If the system is again connected to a normal load, the system can response very quickly since voltage converter 30 has already been in the PWM mode, and the level of the inductor current can be made to quickly reach the required level. Meanwhile, the setting used for the burst mode can be reset to default values as appeared in the initial state, and voltage converter 30 can watch whether any light load condition is happened and respond in a very short time.

Therefore, when switching power supply 30 operates with light load or no load, the time interval between two consecutive times of entering into the burst mode is approximately maintained in a specific range. As exemplified in FIG. 5, the time interval will be maintained approximately around 22 operating periods (equals to 7 DCM switching plus 15 non-switching periods). Once the detected interval is greater than 22 operating periods, the excessive energy transferred after entering the burst mode will be adjusted to a lower level; if the detected interval is less than 22 operating periods, the excessive energy will be adjusted to a higher level. Accordingly, this time interval can be designed such that it is away from the audible frequency range of 20 Hz-20 KHz, or at least avoids the more sensitively audible frequency range of 1 KHz-10 KHz, so as to avoid the generation of audio noise.

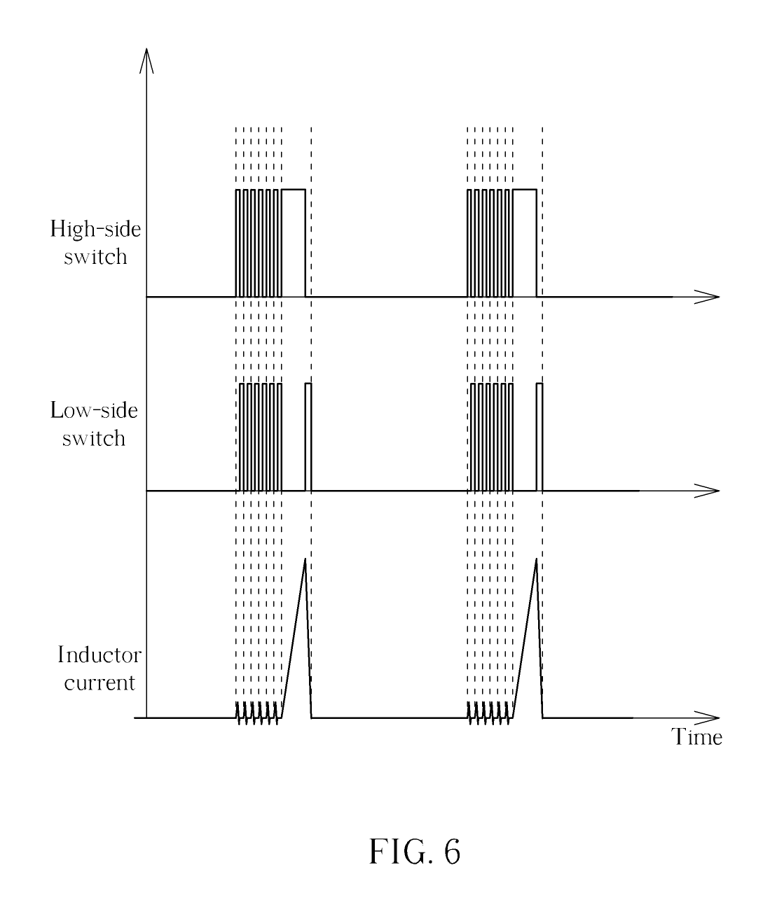

FIG. 6 illustrates a signal diagram of high-side switch HG, low-side switch LG, and inductor current I_L1 of switching power supply circuit 30 operating in alight load condition. When load Z1 is confirmed as alight load, high-side switch HG turns onto output a larger current pulse according to the newly adjusted current energy preset value. Since the output energy of the current pulse is larger than usual, high-side switch HG can stop the switching actions for several consecutive periods (the number of consecutive non-switching periods is 15 as exampled in FIG. 6). When voltage converter 30 starts to output energy based upon the minimum preset energy (i.e. the occurrence of the zero current or very small reverse current) for a number of consecutive times larger than a preset value (the preset value is 7 as exampled in FIG. 6), voltage converter 30 confirms the occurrence of the light load and then adjusts the current energy preset value for outputting a larger current pulse. The embodiment of the present invention waives most switching losses of the high-side switch HG such that the power consumed by the switching actions can be lowered. Meanwhile, the audio noise produced by the switching power supply circuit can be avoided.

Those skilled in the art will readily observe that numerous modifications and alterations of the device and method may be made while retaining the teachings of the invention.

What is claimed is:

1. A control method for a voltage converter comprising:
providing a setting for a power saving mode;
entering the power-saving mode, and making the voltage converter output a preset level of energy according to the setting;
entering a normal mode, determining whether the voltage converter should enter into the power saving mode and detecting an output response of the voltage converter; and
adjusting the setting according to the output response, such that the output response is approximately maintained in a preset range.

2. The control method of claim 1, wherein the output response of the voltage converter is a time interval between two consecutive times the voltage converter entering into the power saving mode.

3. The control method of claim 2 further comprising:
changing the setting and reducing the preset level of energy when the time interval is greater than a preset value.

4. The control method of claim 2 further comprising:
changing the setting, and increasing the preset level of energy when the time interval is less than or equal to a preset value.

5. The control method of claim 1, wherein the voltage converter is used for controlling an inductor for storing energy, and the setting is used for defining the maximal allowable current flowing through the inductor.

6. The control method of claim 1, wherein the voltage converter is used for controlling an inductor for storing energy and used for controlling a power switch of the current flowing through the inductor, and the setting is used for defining a duration of conduction or a number of conducting times of the power switch.

7. The control method of claim 1, wherein, in the normal mode, the voltage converter can output energy either in a first sub-mode or a second sub-mode, the average energy of the first sub-mode is less than that of the second sub-mode, and the control method further comprises:
detecting whether the voltage converter outputs energy in the first sub-mode;
counting a first number of consecutive periods the voltage converter outputting in the first sub-mode; and
making the voltage converter enter into the power saving mode when the first number of consecutive periods is greater than a first preset value.

8. The control method of claim 7, wherein the control method further comprises:
counting a second number of consecutive periods the voltage converter outputting in the second sub-mode; and
resetting the setting when the second number of consecutive periods is greater than a second preset value.

9. The control method of claim 7, wherein the voltage converter is used for controlling an inductor for storing energy, and when the voltage converter outputs energy in the second sub-mode, the inductor current of the inductor turns out to be zero or negative during a switching period.

10. The control method of claim 1, wherein the output response of the voltage converter is the number of non-switching periods between two consecutive times entering into the power saving mode.

11. The control method of claim 1, wherein, the normal mode is a pulse width modulation (PWM) mode, and the power saving mode is a burst mode.

12. A voltage converter comprising:
a state detector for detecting an output of the voltage converter to determine the voltage converter should enter a power saving mode or a normal mode;
an output energy determinator, comprising a setting register, for storing a setting and adjusting the setting according to an output response of the voltage converter operated in the normal mode, making the output response approximately maintained in a preset range; and
a switch controller for controlling a power switch, being operated either in the power saving mode or in the normal mode, and when operated in the power saving mode, making the voltage converter output a preset level of energy according to the setting stored in the setting register.

13. The voltage converter of claim 12, wherein the output response of the voltage converter is the time interval between two consecutive times the voltage converter entering into the power saving mode.

14. The voltage converter of claim 12, wherein the voltage converter further comprises a reverse current detector for detecting the occurrence of the reverse current of the voltage converter.

15. The voltage converter of claim 14, wherein the reverse current detector detects whether the inductor current of the inductor is zero current, to detect the occurrence of the reverse current of the voltage converter.

16. The voltage converter of claim 12, wherein the voltage converter is capable of outputting energy either in a first sub-mode or a second sub-mode, the average energy of the first sub-mode is less than that of the second sub-mode, and the state detector further comprises:
a counter, coupled to the reverse current detector, for counting a first number of consecutive periods the voltage converter outputting in the first sub-mode in the normal mode;
wherein when the first number of consecutive periods is greater than a first preset value, the state detector makes the voltage converter enter into the power saving mode.

17. The voltage converter of 16, wherein the output energy determinator comprises:
a first counter, coupled to the reverse current detector, for counting a second number of consecutive periods the voltage converter outputting in the second sub-mode;
wherein when the second number of consecutive periods is greater than a second preset value, the setting is reset.

18. The voltage converter of 17, wherein the output energy determinator further comprises:
a second counter, for counting a number of consecutive non-switching period the voltage converter outputting no energy in the normal mode.

19. The voltage converter of 18, wherein when the number of consecutive non-switching period is greater than a third preset value, the output energy determinator changes the setting, and reduces the preset energy.

20. The voltage converter of 18, wherein when number of consecutive non-switching period is less than or equal to a third preset value, the output energy determinator changes the setting, and increases the preset energy.
